(19) United States
(12) Patent Application Publication
(10) Pub. No.: US 2017/0308802 A1
(43) Pub. Date: Oct. 26, 2017

(54) SYSTEMS AND METHODS FOR FAILURE PREDICTION IN INDUSTRIAL ENVIRONMENTS

(71) Applicant: Arundo Analytics, Inc., Houston, TX (US)

(72) Inventors: Tor J. Ramsøy, Oslo (NO); Robert Han, San Francisco, CA (US); Mogens L. Mathiesen, Olso (NO); Noah B. S. Kindler, Atherton, CA (US); Martin J. Lee, Sunnyvale, CA (US); Matthew S. Burriesci, Half Moon Bay, CA (US)

(21) Appl. No.: 15/134,905

(22) Filed: Apr. 21, 2016

(51) Int. Cl. G06N 7/00; H04L 29/06; G06N 99/00

(52) U.S. Cl. CPC G06N 7/005; G06N 99/005; H04L 63/0421

(57) ABSTRACT

Methods and accompanying systems are provided for predicting outcomes, such as industrial asset failures, in heavy industries. The predicted outcomes can be used by owners and operators of oil rigs, mines, factories, and other operational sites to identify potential failures and take preventive and/or remedial action with respect to industrial assets. In one implementation, historical data associated with a plurality of outcomes is received at one or more central site servers from one or more data sources, and datasets are generated from the historical data. Using the datasets, a set of models is trained to predict an outcome. A particular model includes sub-models corresponding to a hierarchy of components of an industrial asset. The set of models is combined into an ensemble model, which is transmitted to remote sites.

### BACKGROUND

The present disclosure relates generally to failure prediction modeling and, more particularly, to systems and methods for combining models used to identify and predict industrial machinery failures based on sensor-based data and other information.

Current failure prevention techniques in heavy industries, such as the oil, natural gas, mining, and chemical industries, are generally reactive rather than proactive, and often require manual identification and troubleshooting of faults, breakdowns, and potential failure conditions in industrial systems. Further, such systems are often unique to their individual installations, resulting in a limited ability to transfer failure prevention knowledge among work sites, at least with respect to the operation a particular system as a whole. Such limitations inhibit the ability to model the likelihood of failure based on different features and criteria associated with an industrial or other system.

In some instances, different organizations collect operational and failure data for similar systems, but decline to circulate the data due to confidentiality and security concerns. In addition, modeling of data between common industry members can be difficult due to non-overlapping feature sets that occur due to each party having unique processes or system components. Not all data and outcomes maintained by all parties are stored in a common format, including fraud or distress data stemming from public information (e.g., news articles about plant closings or social media posts about criminal activities). The size of the data also provides a computational challenge to efficiently model, although models based on more data can be more accurate. Current monolithic modeling procedures do not account for additional predictive power that may be provided from other institutions without extensive legal agreements and large amounts of inter-organizational trust.

### SUMMARY

Described herein are computer-implemented methods and accompanying systems to create models over a diverse group of data incompatible to be aggregated or commingled, protect the data with a computer security infrastructure, and transmit the models to a prediction server without transmission of the actual protected data while maintaining anonymity and data confidentiality.

In one aspect, a computer-implemented method includes the steps of: receiving, at one or more central site servers from one or more data sources, historical data associated with a plurality of outcomes; generating, by the central site servers, a plurality of datasets from the historical data; training, by the central site servers and using the datasets, a set of models to predict an outcome, wherein a particular model in the set of models comprises a plurality of sub-models corresponding to a hierarchy of components of an industrial asset; combining, by the central site servers, the set of models into an ensemble model; and transmitting, from the central site servers, the ensemble model to one or more remote sites.

In one implementation, each of the remote sites is configured to receive at least one of real-time data and historical data associated with operation of the remote site, and predict, using at least one of a customized model and the ensemble model, an outcome based on the at least one of real-time data and historical data. A particular predicted outcome can include at least one of a prediction that an asset or a component of an asset is likely to fail, a prediction that an asset or a component of an asset is likely to require maintenance, a prediction of uptime of an asset or a component of an asset, and a prediction of productivity of an asset or a component of an asset. particular predicted outcome can also include a decision relating to underwriting, pricing, or feature activation of an insurance or financial product associated with an industrial activity or installation. Each of the remote sites can be further configured to generate an uncertainty factor based on a lack of information about the predicted outcome, and determine whether a shutdown of an asset is warranted based at least in part on the uncertainty factor. The real-time data and historical data associated with the operation of the remote site can include one or more of sensor data associated with operation of equipment at the remote site, and environmental data.

In another implementation, each of the remote sites is configured to transmit to one or more of the central site servers feedback data associated with a model used by the remote site. The central site servers can receive, from one or more of the remote sites, the feedback data associated with a model used by the remote site, and can update the ensemble model based on the feedback data. The receiving of the feedback data from each of the remote sites can occur asynchronously based on network connectivity of the remote site. The updated ensemble model can be transmitted from the central site servers to one or more of the remote sites.

Various implementations can include one or more of the following features. The historical data associated with the plurality of outcomes includes at least one of historical asset failure data, maintenance log data, and environmental data. The remote sites include industrial sites associated with at least one of oil exploration, gas exploration, energy production, mining, chemical production, drilling, refining, piping, automobile production, aircraft production, supply chains, and general manufacturing. Data transmitted between the central site servers and the remote sites is compressed prior to transmission. A particular remote site is configured to train a customized model used by the remote site to predict an outcome using at least one of real-time data and historical data associated with one or more assets at the particular remote site. A particular remote site is configured to transmit to one or more of the central site servers a particular model used by the remote site, wherein the particular model is designated as shareable or not shareable with other remote sites. Fees paid by a particular remote site for use of the ensemble model are based on at least one of the particular remote site providing a model to the central site servers, the particular remote site providing data associated with usage of a model to the central site servers, and an amount of usage of the ensemble model by the particular remote site. Combining the set of models into the ensemble model includes determining a weighting of each model in the set of models based on a predictive power of the model, and combining the set of models into the ensemble model based at least in part on the weighting of the models. The central site servers pre-process historical data to anonymize information that could identify a person or entity.

Other aspects include corresponding systems and non-transitory computer-readable media. The details of one or more implementations of the subject matter described in the present specification are set forth in the accompanying drawings and the description below. Other features, aspects, and advantages of the subject matter will become apparent from the description, the drawings, and the claims.

### BRIEF DESCRIPTION OF THE DRAWINGS

In the drawings, like reference characters generally refer to the same parts throughout the different views. Also, the drawings are not necessarily to scale, emphasis instead generally being placed upon illustrating the principles of the implementations. In the following description, various implementations are described with reference to the following drawings, in which:

FIG. 1 depicts a flow diagram of an example method for generating an ensemble model according to an implementation.

FIG. 2 depicts a computing system according to an implementation.

FIG. 3 depicts a computing system according to another implementation.

FIG. 4 depicts a data flow diagram for an example ensemble model according to an implementation.

FIG. 5 depicts a data flow diagram of an example method for generating a classifier based on an aggregate of models according to an implementation.

FIG. 6 depicts a computing system according to another implementation.

FIG. 7 depicts a computing system according to another implementation.

FIG. 8 depicts a data flow diagram of a system for predicting outcomes for insurance and financial product applications according to an implementation.

FIG. 9 depicts a data flow diagram of a system for predicting outcomes for insurance and financial product applications according to an implementation.

FIG. 10 depicts a flow diagram of a method for predicting an outcome based on an ensemble model according to an implementation.

### DETAILED DESCRIPTION

Subject matter will now be described more fully hereinafter with reference to the accompanying drawings, which form a part hereof, and which show, by way of illustration, example implementations. Subject matter can, however, be implemented in a variety of different forms and, therefore, covered or claimed subject matter is intended to be construed as not being limited to any example implementations set forth herein; example implementations are provided merely to be illustrative. It is to be understood that other implementations can be utilized and structural changes can be made without departing from the scope of the present disclosure. Likewise, a reasonably broad scope for claimed or covered subject matter is intended. Among other things, for example, subject matter can be implemented as methods, devices, components, and/or systems. Accordingly, implementations can, for example, take the form of hardware, software, firmware or any combination thereof (other than software per se). The following detailed description is, therefore, not intended to be taken in a limiting sense. Throughout the specification and claims, terms can have nuanced meanings suggested or implied in context beyond an explicitly stated meaning. Likewise, the phrase “in one implementation” as used herein does not necessarily refer to the same implementation and the phrase “in another implementation” as used herein does not necessarily refer to a different implementation. It is intended, for example, that claimed subject matter include combinations of example implementations in whole or in part.

Described herein are systems and method for predicting outcomes (e.g., equipment and other asset failures, needs for maintenance) in a variety of heavy industries, such as the oil and gas, natural gas, mining, chemicals industries, as well as predicting outcomes in other industries including, but not limited to, the automotive, aviation, and general manufacturing industries. The predicted outcomes can be used by owners and operators of manufacturing plants, oil rigs, mines, factories, utilities, and the like, to identify potential failures and take preventive and/or remedial action with respect to industrial assets (e.g., oil rigs, drilling and mining equipment, chemical plant systems, manufacturing and fabrication equipment, farm equipment, construction equipment, plants, railroad and other transportation systems, vehicles, and other operational systems and equipment used in industrial or commercial environments). In further implementations, the present techniques can also be applied to determine certain financial, insurance or health predicted outcomes, which can, for example, be used as tools for risk assessment, capital allocation, and underwriting (e.g., by underwriters for applications of insurance or credit to determine risk similar to how FICO scores are used to evaluate the creditworthiness of applicants for loans). The present techniques can also be extended to provide batched or real-time underwriting for industrial insurance on heavy assets or buildings.

The present techniques include generating models that make predictions or classifications based on training sets of data. For example, using training data relating to equipment operation and/or environmental data, a particular model can categorize an equipment assembly or particular component as likely to fail or need maintenance within a particular amount of time (e.g., immediately, within ten minutes, within 3 days, etc.). As another example, a particular model can identify which category in a set of categories (e.g., underwriting classification in terms of mortality, morbidity, health outcomes, and credit and fraud risks) applicants for an insurance (e.g., life, annuity, health, home, automobile, accident, business, investment-orientated, etc.) or financial product (credit, loans, etc.) belong based on training data.

Training data can be formed from a plurality of datasets originating from a plurality of data sources (e.g., industry equipment operators and manufacturers, operational facilities, insurance and financial underwriters, etc.). One or more of the datasets can include arbitrary or disparate datasets and outcomes that cannot be commingled or aggregated. The training data can be used to train machine learning algorithms to transform raw data (e.g., data that has not been modified or kept in its original format) into a plurality of models that can be used to evaluate and predict outcomes (e.g., equipment and other asset failures, scores of applicants for insurance or financial products, such as underwriter classification, score, risk drivers, predicted life expectancy or predicted years of life remaining, and so on).

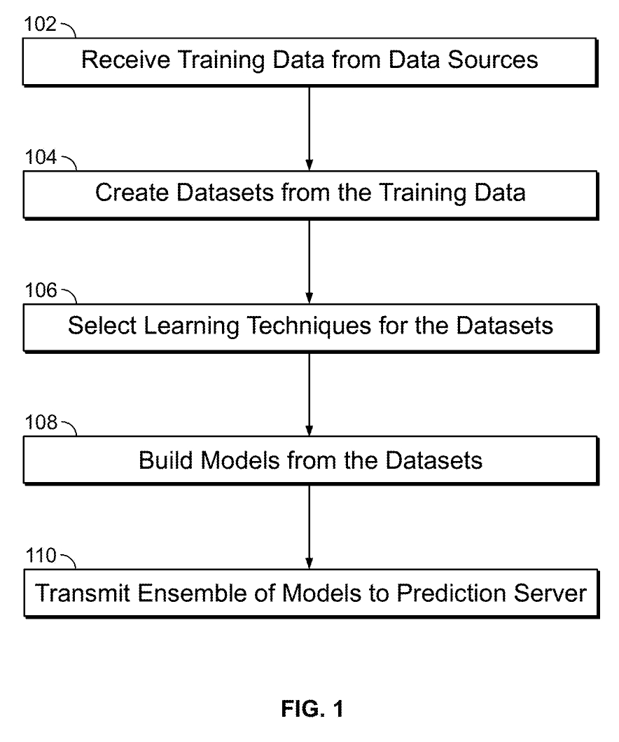

FIG. 1 illustrates a flow diagram of a method for generating an ensemble model according to an implementation. Training data is received from a data source, such as an industrial equipment operator or manufacturer, financial or insurance underwriter, or other source, step 102. The training data can include historical and/or real-time operational and performance parameters associated with industrial equipment, for example, weight on bit, pressure, vibration, temperature, flow rate, drilling rate, power consumption, power output, and other data observable by sensors, provided in equipment specifications, or otherwise, in industries such as oil and gas, mining, energy production, and the like. The operational data can be provided and correlated with maintenance logs, historical equipment failure data, and the like, so that the model can be trained to predict failures and other outcomes based on, for example, incoming real-time data. In other implementations (e.g., for underwriting policies for individuals or industrial assets), the training data can include information from existing or past policies such as, where applicable, equipment identification information, available equipment specifications, mean time between failures (MTBF) and mean time to failure (MTTF) and other equipment reliability measures, personal identification information, date of birth, original underwriting information, publicly purchasable consumer data, prescription order histories, electronic medical records, insurance claims, motor vehicle records, and credit information and death or survival outcomes. According to one implementation, training data from each of the data sources is uniquely formatted and includes disparate types of information.

The training data can be received from servers, sensors, monitoring equipment, operational process control systems, and databases of various data sources and processed by a modeling engine without proprietary data necessarily leaving the facilities of the data source or being shared with other data providers. In particular, a modeling architecture is provided that allows use of a dataset from the servers of the data sources without directly transmitting that dataset outside their facilities. Rather, individual models created from the datasets can be used and shared among the data sources, as well as combined into an ensemble model that can be distributed or otherwise made available to some or all of the data sources. As referred to herein, “ensemble model” or “ensemble of models” can refer to a set or hierarchy of one or more models generated by and received from one or more sources, and can also refer to a single, combined supermodel assembled from one or more models generated by and received from one or more sources. Usage of anonymous and synthesized training data allows anonymized insights, error correction, fraud detection, and provides a richer dataset than a single dataset or data from a single entity. Training data can also be retrieved and extracted from equipment manufacturer databases, industrial, commercial and consumer data sources, prescription databases, credit data sources, public web queries, and other sources, as applicable to the particular implementation. Modeling engines are operable to process and generate models from training data originating from a variety of servers, databases, and other electronic data sources.

The training data can be transmitted over a network and received by a modeling engine on a local server, which can be located behind the applicable facility's firewall or at a remote server or computing device designated by or to the facility. Servers can vary widely in configuration or capabilities, but a server can include one or more central processing units and memory, the central processing units and memory specially configured (a special purpose computer) for model building or processing model data according to various implementations. A server can also include one or more mass storage devices, one or more power supplies, one or more wired or wireless network interfaces, one or more input/output interfaces, or one or more operating systems, such as Windows Server, Mac OS X, Unix, Linux, FreeBSD, or the like. Various system architecture implementations are described further, below.

Communications and content stored and/or transmitted among servers can be encrypted using asymmetric cryptography, Advanced Encryption Standard (AES) with a 256-bit key size, or any other encryption standard known in the art. The network can be any suitable type of network allowing transport of data communications across thereof. A network can also include mass storage, such as network attached storage (NAS), a storage area network (SAN), cloud computing and storage, or other forms of computer or machine readable media, for example. In one implementation, the network is the Internet, following known Internet protocols for data communication, or any other communication network, e.g., any local area network (LAN), or wide area network (WAN) connection, wire-line type connections, wireless type connections, or any combination thereof.

Datasets as well as sub-datasets or feature sets within each dataset can be created from each of the training data retrieved from the data sources including disparate kinds of data and features, some of which can overlap and/or differ in formats, step 104. Learning techniques are selected for each of the plurality of datasets by a modeling engine, step 106. Choices include, but are not limited to support vector machines (SVMs), tree-based techniques, artificial neural networks, random forests and other supervised or unsupervised learning algorithms. Further description and details of these learning techniques are described in U.S. Patent Application Publication No. 2006/0150169, entitled “OBJECT MODEL TREE DIAGRAM,” U.S. Patent Application Publication No. 2009/0276385, entitled “ARTIFICIAL-NEURAL-NETWORKS TRAINING ARTIFICIAL-NEURAL-NETWORKS,” U.S. Pat. No. 8,160,975, entitled “GRANULAR SUPPORT VECTOR MACHINE WITH RANDOM GRANULARITY,” and U.S. Pat. No. 5,608,819, entitled “IMAGE PROCESSING SYSTEM UTILIZING NEURAL NETWORK FOR DISCRIMINATION BETWEEN TEXT DATA AND OTHER IMAGE DATA,” which are herein incorporated by reference in their entirety.

Models are generated from the datasets using the selected learning techniques, step 108. Generating models includes building sets of models for each of the datasets. Features from the datasets can be selected for model training. A model can comprise data representative of a computing system's (such as a modeling engine or server) interpretation of training data including certain information or features. A family of feature sets within each dataset can be selected using, for example, iterative feature addition, until no features contribute to the accuracy of the models beyond a particular threshold. To improve the overall model, certain features can be removed from the set of features and additional models can be trained on the remaining features. Training additional models against the remaining features allows for the determination of an optimal set of features that provide the most predictive power when the removed feature sets may not be available in other datasets. Examples of most predictive features in the case of underwriting include, for example, location, date of birth, type of medications taken, and occupation.

According to various implementations, ensemble learning (e.g., by a special-purpose computing device such as a modeling engine or server) is employed to use multiple trained models to obtain better predictive performance than could be obtained from any individual constituent trained model. Ensemble learning combines multiple hypotheses to form a better hypothesis. A given ensemble model can be trained and then used to make predictions. The trained ensemble represents a single hypothesis that is not necessarily contained within the hypothesis space of the models from which it is built. Thus, ensembles can be shown to have more flexibility in the functions they can represent. Ensembles are capable of yielding better results when there is a significant diversity among the models. Therefore, disparate datasets from the plurality of data sources are can be beneficial in providing diversity among the models the ensembles combine. Furthermore, the exclusion of features, as described above, can provide this diversity.

A plurality of models can be generated for each of the plurality of datasets as well as for each individual dataset. For example, a plurality of models can be generated from a given feature set where each of the plurality of models is trained using unique feature combinations from the feature set. Generating the models can further include testing the models, discarding models with insufficient predictive power, and weighting the models. That is, the models can be tested for their ability to produce a correct classification greater than a statistical random chance of occurrence. Based on “correctness” or predictive ability from the same dataset, the models can be assigned relative weightings that then affect the strength of their input in the overall ensemble model.

In one implementation, a plurality of models is generated in a hierarchical formation. For example, an installation of equipment on an offshore oil rig can be represented by a hierarchy of individual models that are specific to components (e.g., pump, valve, etc.) or subsets made of components (e.g., drill assembly, HVAC system, etc.), that compose the larger setup. Thus, in one instance, if a model associated with a particular type of blowout preventer predicts that a failure is likely, the same model could be useful for the same type of blowout preventer on other oil rigs, even if such rigs have different configurations than the first rig. Accordingly, the blowout preventer model can be provided to a centralized source that creates a combined ensemble model and distributes the ensemble model to the other rigs.

In one implementation, the models are transmitted via network or physical media to a prediction server or an engine on a central server that can include a disk drive, transistor-based media, optical media, or removable media, step 110. The models include a combination of disparate model types (generated from the selected learning techniques). Results from the models can be weighted and combined or summarized into an end classifier to produce the outcome. The prediction server is configured to be able to utilize the ensemble model (the interpretation data generated by modeling engines or servers) to predict an outcome including a failure prediction, composite score, continuous or categorical outcome variables, uncertainty factors, ranges, and drivers for application queries. Predicted outcomes from the prediction server can be used to, for example, inform equipment operators and maintenance personnel of likely failure in physical assets, marketing of financial or insurance products (or activating features of those products) to a new or existing customer, target marketing of financial or insurance products to a specific class or type of customer, inform fraud detection during or after an evaluation of an application, and inform the offer of incentives or dividends for behavior after the extension of credit or insurance. Additionally, sensitivity analysis of the ensemble model can be performed to determine which features are the largest drivers of a predicted outcome. In the case of underwriting, a sensitivity analysis includes varying certain features, such as, body mass index (BMI), number of accidents, a smoker or non-smoker, etc., by plus or minus a given range of values for continuous variables, toggling a value for binary, or permuting categorical variables and re-running the ensemble models. Features with the greatest influence on the predict outcome can be identified based on differences in the re-running of the ensemble model. Various other features can be varied depending on the particular implementation.

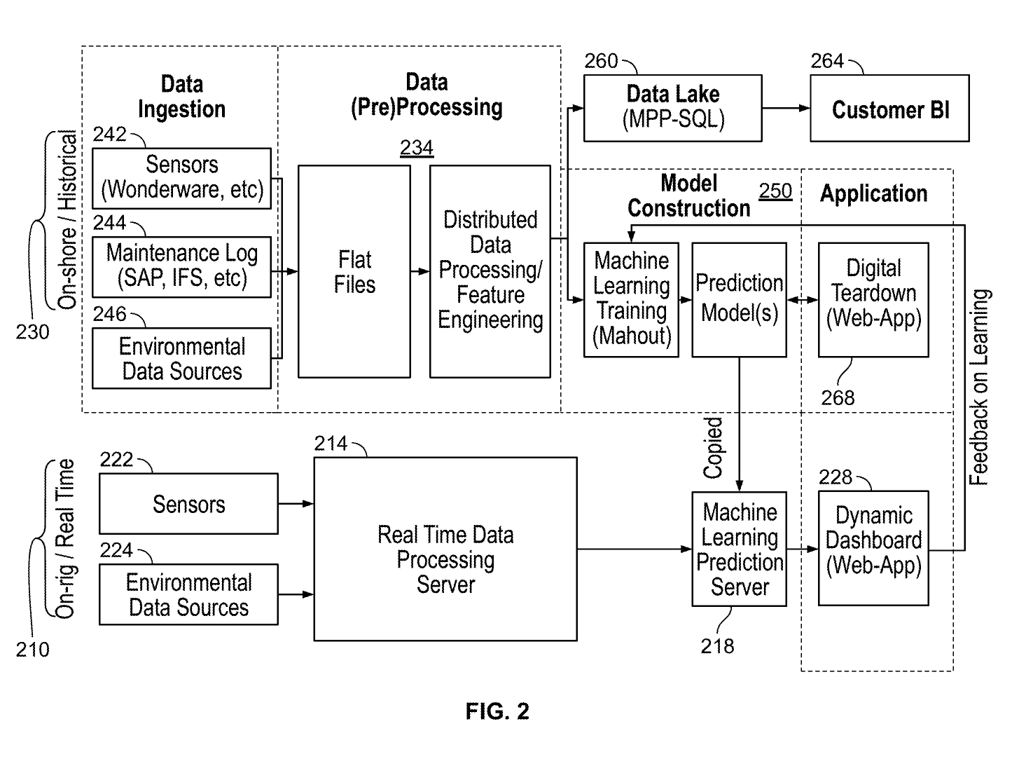

FIG. 2 depicts a computing system according to an implementation. Example applications of the computing system according to this implementation include, but are not limited to, predicting industrial asset and equipment failures and maintenance needs. The computing system includes a real-time data subsystem 210 and historical data subsystem 230. In the oil rig example, the real-time data subsystem 210 is generally situated locally on the oil rig itself, where sensor and other data is available in real-time; whereas the historical data subsystem 230 is generally situated onshore, where it can serve as a centralized location for receiving and processing data from multiple oil rigs and other sites. The present implementation This can be used for setups that have limited ability to transfer data among separate sites (e.g., between an offshore oil rig and an onshore data facility), whether because of lack of network connectivity, limited bandwidth, or otherwise. Accordingly, transfers of data between real-time data subsystem 210 and historical data subsystem 230 can be made asynchronously, rather than on a continual basis, when a network connection and sufficient bandwidth is available.

Real-time data subsystem 210 includes real-time data processing server 214, which receives and processes raw data from various real-time or other data sources, including sensors 222 and environmental data sources 224. Machine learning prediction server 218 receives the processed real-time data from real-time data processing server 214 and uses it as input to an ensemble model or a trained model customized for the particular site. Based on the input, machine learning prediction server 218 outputs an outcome (e.g., a prediction that a particular component or system is likely to fail or is in the process of failing). This outcome can be provided to dynamic dashboard 228, which can be, for example, a web or native application with a graphical user interface that displays the outcome to an operator. In addition, information regarding the outcome, the associated input data can be provided as learning input back to a customized model onsite and/or an ensemble model maintained by historical data subsystem 230.

Historical data subsystem 230 includes data pre-processing components 234, which transform raw or uniquely formatted data into useful formats, such as simple formatted flat files. In some implementations, data pre-processing components 234 compress data prior to its use in a model for optimizing memory or processor usage. Data pre-processing components 234 can receive data from various sources including, but not limited to, historical sensors data 242 (e.g., sensor data provided via a supervisory control and data acquisition (SCADA) or other operational process monitoring or control system provided, e.g., by WONDERWARE), maintenance log databases 244 (accessible, e.g., via a system provided by SAP or IFS), and environmental data 246 (e.g., historical data from weather services, measurements of wind speed, wave height, air temperature, etc.).

The pre-processed data is provided to model construction components 250, which use the pre-processed data (along with data receiving from real-time data subsystem 210) to train a prediction model (e.g., an ensemble model that is a supermodel of the models generated by each individual site). The model construction components 250 can implement a suitable machine learning platform, such as APACHE MAHOUT. Upon an update to the ensemble model, on a periodic basis, or when data transfer is otherwise possible between real-time data subsystem 210 and historical data subsystem 230, model construction components 250 can provide the current ensemble model to machine learning prediction server 218. Machine learning prediction server 218 can then continue to update the local ensemble model, in effect creating a customized model, using real-time data gathered onsite, until it next receives an update of the ensemble model.

The pre-processed data can also be provided to data lake 260 (e.g., a massively parallel processing (MPP) SQL database), which can be queried by business intelligence (BI) customer systems 264, allowing customers to view performance, failure, maintenance, and other data associated with the operation of one or more sites. Further, a digital-teardown user facing-application 268 (e.g., a web application) in the historical subsystem 230 enables end users to visualize the completeness of information and its availability through a hierarchical representation of the underlying asset (e.g., an industrial system organized into hierarchies of subsystems and their underlying components).

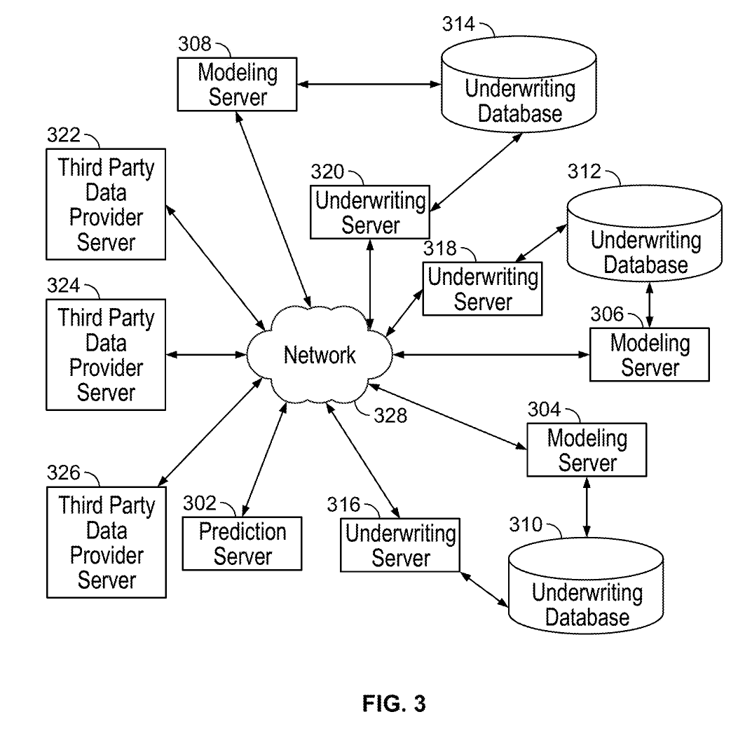

FIG. 3 presents a computing system according to another implementation. Example applications of the computing system according to this implementation include, but are not limited to, financial and insurance underwriting, and risk management. While the example of underwriting is used to illustrate this computer system, it should be appreciated that servers and databases can be provided by or associated with data sources other than underwriters, models can be generated using other types of data, and predictions can relate to outcomes other than those associated with underwriting, such as industrial equipment failure, performance, maintenance, and the like.

The computing system comprises prediction server 302 communicatively coupled to modeling server 304, modeling server 306, and modeling server 308 via network 328. The modeling servers can create sets and subsets of features from the training data based on the data stored within the underwriting databases 310, 312, and 314. That is, modeling server 304 creates training data from underwriting database 310, modeling server 306 creates training data from underwriting database 312, and modeling server 308 creates training data from underwriting database 314.

The data stored in underwriting databases 310, 312, and 314 can include information from existing or past policies such as personal identification information, date of birth, original underwriting information, purchasable consumer, credit, insurance claims, medical records data, and death or survival outcomes. Data stored in underwriting databases 310, 312, and 314 can also be unique or proprietary in form and in content among each underwriting database. Some of the underwriting servers, modeling servers and underwriting database can be co-located (e.g., a corporate location) and protected behind a firewall and/or computer security infrastructure. For example, underwriting server 316, modeling server 304, and underwriting database 310 can be located in first common location, while underwriting server 318, modeling server 306, and underwriting database 312 can be located in a second common location and underwriting server 320, modeling server 308, and underwriting database 314 can be located in a third common location. In other implementations, one or more of the underwriting servers, modeling servers and underwriting database can be located remotely from each other.

Models can be generated by the modeling servers 304, 306, and 308 from the training data (learning from the training data). A given modeling server is operable to generate ensemble models from the sets and subsets of features created from the training data and determine relative weightings of each model. The modeling servers can be further operable to test the ensemble models for correctness. The relative weightings can be assigned based on relative correctness of the ensemble models. Prediction server 302 can receive or retrieve a group of models from each of the modeling servers along with the relative weightings.

In one example, utilizing the ensemble of models, the prediction server 302 is able to provide predictions for new insurance applications. Queries can be submitted to the prediction server 302 from any of underwriting server 316, 318, or 320. A query can include insurance application data such as personal identifying information (such as name, age, and date of birth), policy information, underwriting information, an outcome variable for life expectancy as calculated from the underwriters' decision, and actuarial assumptions for a person in an underwriting class and of that age. Each of the groups of models can be given an additional weighting among each group received from the modeling servers. In other words, an group of models from modeling server 304 can be assigned a first weighting, an group of models from modeling server 306 can be assigned a second weighting, and an group of models from modeling server 308 can be assigned a third weighting. The weightings assigned to each group of models can be based on, for example, the number of features or volume of training data used to create the group of models.

The insurance application data from a query can be entered into each of the models in the ensemble of models to provide an outcome prediction. The outcome prediction can include outcome variables associated with mortality, morbidity, health, policy lapse, and credit and fraud risks, or suitability for marketing campaigns. In addition, third party and public information can be collected from third party server 322, third party server 324 and third party server 326 and used to influence or augment results of the ensemble of models. Third party information can include prescription history, consumer purchasing data, and credit data. Public information includes for example, “hits” associated with applicants' names on the Internet, driving records, criminal records, birth, marriage and divorce records, and applicants' social network profiles (e.g., LinkedIn, Facebook, Twitter, etc.). Alternatively, one or more of the third party and public information can be included in the data stored in underwriting databases 310, 312, and 314 and included in the generation of the ensemble model.

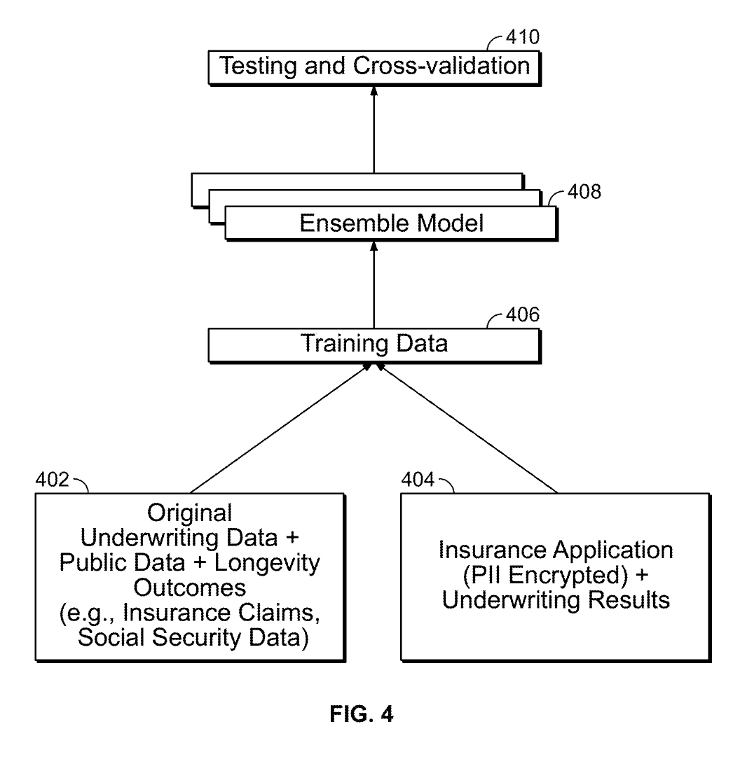

Referring to FIG. 4, and depending on the particular implementation, data 402 received by a modeling engine can include, but is not limited to, sensor data (e.g., individual sensor readings, averages, maximums, minimums, standard deviations and other values indicating vibration, temperature, air pressure, fluid pressure, velocity, position, load, speed, valve state, acceleration, heave, pitch, roll, tilt, voltage, amperage, rotation, fluid level, flow rate, volume, piston stroke rate, piston stroke count, power, torque, elevation, weight, and other parameters), maintenance log information, historical system failure data, and equipment specifications.

Data 402 can also include, in the case of underwriting or risk assessment, for example, information from existing or past insurance policies, original underwriting data, public data, actual (or longevity) outcomes, a Death Master file (e.g., Social Security Death Index, life insurance claims data) from servers of the underwriting parties, medical records, driving records (e.g., Department of Motor Vehicles), prescription history, and other Health Insurance Portability and Accountability Act (HIPAA) protected data. Original underwriting data can include information associated with previous policies, information associated with the underwriting of the policies, publicly purchasable consumer data, and age at death (or current survival) as an outcome variable. Other sources of data can include data produced by wearable technologies, collaborative knowledge bases (e.g., Freebase), and social networking/media data associated with an individual (e.g., applicant). Several features of an individual can be gleaned and inferred from data 402. For example, it can be determined that an applicant for life insurance is living a healthy lifestyle based on purchases of health books, ordering healthy food, has an active gym membership, has a health and fitness blog, runs two miles every day, and posts exercising activities on social networking websites.

The modeling engines can be located within a firewalled enterprise network or with the facilities of the servers storing data 402. Data 402 can be pre-processed to anonymize some or all information that could identify a person or entity. The data can also be normalized prior to or during processing cleaned to remove or correct potentially erroneous data points. Data 402 can also be augmented with additional information prior to or during processing, where missing data fields are replaced with a value, including the mean of the field for a set, selected randomly, or selected from a subset of data points.

A plurality of learning techniques can be selected for learning on datasets created from data 402. The data 402 is used as training data 406 for model learning. Training data 406 comprises a plurality of datasets created from data 402. A given dataset includes features selected from data received from a given data source. Models developed from each data source's data contributes to the ensemble model 408. That is, the ensemble model 408 can be an aggregate or combination of models generated from data of a plurality of data sources. In addition, multiple types of underlying models can be produced from the plurality of datasets to comprise ensemble model 408.

Ensemble model 408 can be built from feature sets by modeling engines on one or more servers (e.g., as designated and located by the data sources). A family of feature sets can be chosen within each dataset for modeling. Thus, a plurality of ensemble models 408 can be generated for each of the plurality of datasets as well as for each individual dataset. The set of features can be selected using iterative feature addition or recursive feature elimination. Sets of features can also be selected based on guaranteed uniformity of feature sets across all datasets or lack of a large number of data bearing features. Thus, optimal models can be produced using particular data subset(s). For example, a plurality of models can be generated from a given dataset where each of the plurality of models is trained using unique feature combinations from the given dataset. This allows for reducing problems related to overfitting of the training data when implementing ensemble techniques.

Overfitting generally occurs when a model is excessively complex, such as having too many parameters relative to the number of observations. In particular, a model is typically trained by maximizing its performance on some set of training data. However, its efficacy is determined not by its performance on the training data but by its ability to perform well on test data that is withheld until the model is tested. Overfitting occurs when a model begins to memorize training data rather than learning to generalize from trend. Bootstrap aggregating (bagging) or other ensemble methods can produce a consensus decision of a limited number of outcomes. In order to promote model variance, bagging trains each model in the ensemble using a randomly drawn subset of the training set.

In one implementation, a feature condensation can be used where certain features can be summarized. For instance, categorizing aberrations in equipment sensors readings into minor, moderate, and severe; detecting the type of prescriptions taken by an individual and classifying them into high, medium, and low risk; summing the occurrences of certain phrases synonymous to “accident” on a driving record of the individual; and extracting critical features from words or images on a social networking profile page of the individual, can be performed to synthesize a smaller number of critical features that have a great influence on determining an outcome from a much larger set of underlying observed features. Optionally, a subset of data can be used to weight the models produced from different datasets. Due to the computationally intensive nature of learning, the family of feature sets from the dataset can be distributed to multiple servers for modeling. For large datasets, sub-datasets can be used instead to build models. The sub-datasets can be created by sampling (with replacement) the dataset.

Testing and cross-validation 410 can include testing each model on the dataset by utilizing a test set of data points held out or omitted from the training dataset to determine accuracy, discarding models with insufficient predictive power, and determining overall weighting of the models within each dataset. In the initial training of ensemble model 408, a set of features can be removed from a given sub-dataset, thereby removing a subset of data bearing features, and additional models trained using the remaining features. Training additional models of the ensemble against these subsets of the total feature set allows for a broader set of models to be created and evaluated. According to another implementation, random subsets of a feature set can be eliminated and iterative feature addition can be repeated to obtain a diverse set of models. Cross-validation includes a model validation technique for assessing how the results of modeling will generalize to an independent data set to estimate how accurately the ensemble model will perform in practice. A dataset can be defined to test the ensemble model to limit problems like overfitting and provide an insight on how the models can correctly predict outcomes for an unknown dataset, for example, from a new machine assembly or a real underwriting application. The cross-validation can include partitioning a dataset into complementary sub-datasets, performing analysis on one sub-dataset, and validating the analysis on another sub-dataset (the validation/test set). Multiple rounds of cross-validation can be performed using different partitions and the validation results can be averaged over the rounds. The weighting of each model within each dataset can be related to the number of records represented in each sub-dataset of a dataset that gave rise to that model by a power law, or related to its predictive power as determined by regression or another machine-driven assignment of weights utilizing a set of test data that can be used by all models to be weighted

Sets of models (a set corresponding to each dataset) can be transmitted from the modeling building engines and stored on a prediction engine located on a central server(s). The prediction engine can provide a classifier comprising the ensemble of models to aid in various activities (e.g., monitoring system operations, planning for equipment maintenance and replacement, underwriting life insurance applications including the monitoring of underwriting decisions quality, and updating of the classifier over time). The classifier is operable to estimate or predict outcomes related to physical asset failure and maintenance needs, insurance claim frauds, medical issues, investment risk, accident likeliness, etc. Predicted outcomes from the prediction server can be used, for example, to alert an equipment operator of a pending failure in a system or a system component; to inform a maintenance team that a particular asset is likely to need repair or replacement; to market financial or insurance products to a consumer or existing customer; for target marketing of financial or insurance products to a specific class or type of customer; to inform fraud detection during or after an evaluation of an application; and to inform an offer of incentives or dividends for behavior after the extension of credit or insurance. Ensemble model 408 can be shared among the plurality of data sources without necessarily disclosing each other's underlying data or identities. Advantageously, the sharing of ensemble model 408, which can be updated and modified based on models generated by individual data sources or facilities, allows for predictive behavior identified by one model (e.g., determining that a particular component is likely to fail when values of certain operational parameters are observed in a particular pattern) to be utilized by other prediction engines that have not yet learned to recognize the behavior or make accurate predictions based on it. In some implementations, a given data source or other facility can maintain a customized model that is unique from the shared ensemble model 408.

Queries can be submitted to the prediction engine to evaluate new and incoming data (e.g., equipment sensor readings, maintenance log data, insurance applications and renewals, etc.). For example, in an implementation directed to predicting outcomes for underwriting, data 404 can include encrypted personal identifying information (such as name, age, and date of birth), policy information, underwriting information, an outcome variable for life expectancy as calculated from the underwriters' decision, and actuarial assumptions for a person in an underwriting class and of that age. Values from data 404 can be entered into the ensemble model 408. The prediction engine is operable to run the ensemble model 408 with the data 404 and results from the ensemble model 408 can be summarized and combined (regardless of type of the underlying models) to produce outcome scores, variables, and an uncertainty factor for those variables. The data 404 can also be used by the modeling engines for training additional models (e.g., as the actuarial assumptions and the underwriting outcomes describe an outcome variable, life expectancy). This training can occur periodically, e.g., daily, weekly, monthly, etc.

The variables can be ordered outcome variables (continuous and binary) and categorical variables such as, in the case of underwriting, years until death, years until morbidity, risk classes, potential fraud risk, and potential risk of early policy lapse. Ordered outcome variables can be assigned numerical scores. There can be a certain number of models that produce favorable outcome values or predictions, a certain number of models that produce unfavorable outcome values or predictions, and a certain number of models that produce inconclusive outcome values or predictions. The mean and variance (or standard deviation), median, or the mode of those numerical scores (or variables) can be determined to create a voting mechanism based on dispersion of risk classes and weights. According to one implementation, sets of models that show more accurate predictions are given greater weight over other sets of models. In an exemplary implementation, the outcome variables with the most votes are identified and can be used to determine an underwriting decision for a particular application query.

Lack of information, about a system, physical asset, customer or potential risk, can be used to generate an uncertainty factor. Uncertainty factors are used to compensate for a deficiency in knowledge concerning the accuracy of prediction results. For example, in industrial operations, the uncertainty factor can be used in conjunction with one or more of subsystem safety, necessity to a system or installation, regulatory implications, overall cost, cost to repair, and/or potential for additional costs, in order to determine if a shutdown of equipment is warranted. As another example, in risk assessment, the uncertainty factor is set to enable risk assessment while avoiding underestimation of the risk due to uncertainties so that risk assessment can be done with a sufficient safety margin. As this value gets higher, the risk assessment becomes less reliable. According to one implementation, the arithmetic mean of ordered outcome variable sets produced by models can be taken to provide a high granularity prediction, and the variance of those same sets provides a measure of uncertainty. In particular, an arithmetic mean can be taken of any continuous variables and the variance, standard deviation, outliers, range, distribution, or span between given percentiles, can be used to calculate an uncertainty factor. In another implementation, categorical variables can be converted into continuous variables via a conversion formula, that of which an arithmetic mean of the continuous variables can then be taken and their variance, standard deviation, outliers, range, distribution, or span between given percentiles, can be used to calculate the uncertainty factor. The uncertainty factor can be an input to a decision on whether or not to, for example, effect a system shutdown on account of likely component failure, or reject an application in the underwriting process. The uncertainty factor can suggest that intervention in the decision process may be necessary. The uncertainty factor can be represented on a bar chart or a dot plot to illustrate the uncertainty factor.

The prediction engine can further perform a sensitivity analysis of the model group used to determine which values of which features are the largest drivers of the outcome produced by the ensemble model. For failure prediction, the feature variables that have the most impact on the outcome can vary from system to system. For example, a tunnel boring machine exhibiting a reduction in speed of the bore and an increase in temperature of the engine can indicate a high probability of breakdown within fifteen minutes. In other systems, sensor readings relating to vibration, for example, can be more influential on the outcome. In the case of underwriting, feature variables such as BMI, driving history, being a smoker or non-smoker, and a history of late bill payments can greatly affect outcomes produced by the overall ensemble model. Each feature variable associated with an individual query can be varied and used to re-run the ensemble model to produce different outcomes variables. The feature variables can be perturbed by a preset, user-selected, or algorithmically-selected amount or number of gradations to determine the effect of the perturbation on the final outcome variable(s). Features that produce the greatest change in the outcome variables when varies can be identified to an end-user (e.g., operator, underwriter) to indicate the drivers. For example, features can be perturbed in each direction by 10% of the difference between the cutoff values for the 25th and 75th percentiles for continuous variables or ordered discrete variables with more than 20 values. All others (including binaries) can be perturbed one value, if available. Perturbations (e.g., top five) with the largest changes on the mean value of the set of models can be identified and reported. The sensitivity analysis can be used to determine the certainty of the ensemble model and/or to communicate drivers of an outcome to a requesting body (e.g., an equipment operator or querying underwriter).

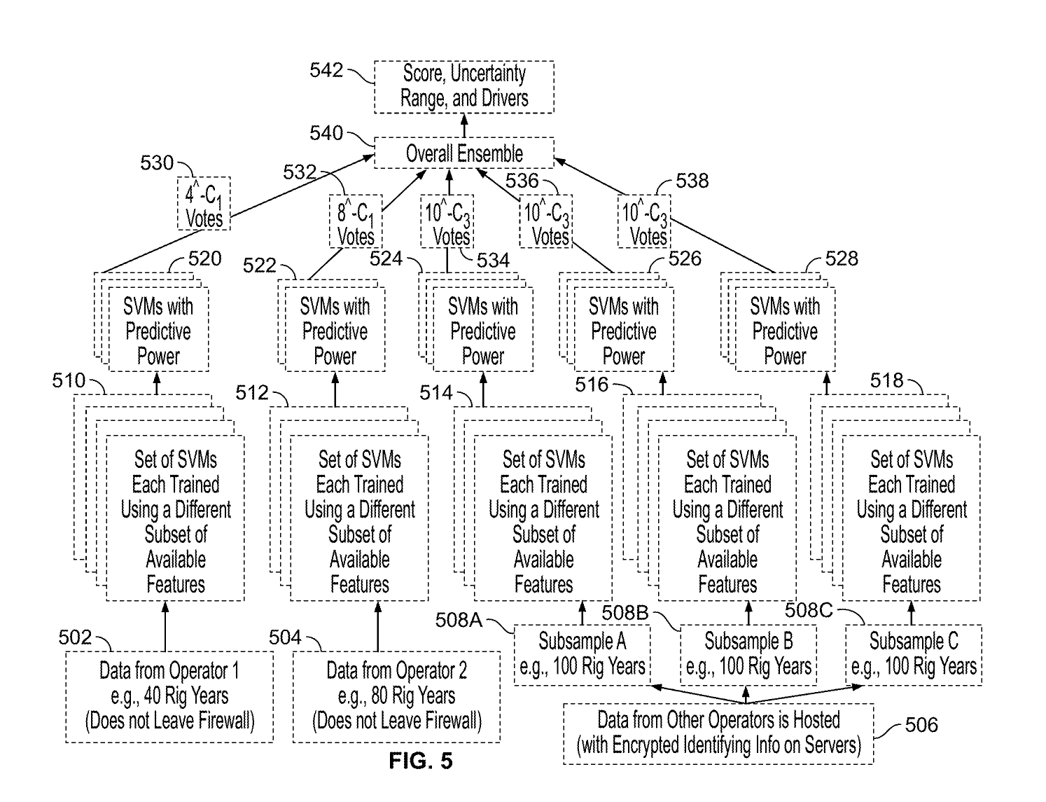

FIG. 5 illustrates a data flow diagram of a method for generating a classifier based on an aggregate of models according to an implementation. The aggregated models are usable to develop a classifier for predicting outcomes according to the various implementations described herein (e.g., outcomes associated with equipment failures, maintenance needs, and insurance and financial underwriting). Individual models can be learned from datasets comprising a plurality of data sampled from data 502, 504 and 506. The data 502, 504, and 506 can include maintenance logs, historical failure data and associated equipment operating parameters, information of policies (personal identification information, date of birth, original underwriting information, publicly purchasable consumer data, and death or survival outcomes) and other types of information associated with systems, operators, policies, policy applicants, and so on, as applicable. In the depicted implementation, data 506 comprises larger datasets, for example, data including over 100,000 historical system failure records, policies, etc. Sub-datasets can be created for larger datasets or datasets can be restricted to sub-datasets defined by the need to not commingle certain sub-datasets to enable learning across larger datasets too large to train on a server or is substantially larger relative to other smaller datasets. The sub-datasets can be created by sampling (e.g., random with replacement) from the larger datasets.

One or more of machine learning techniques can be chosen from a selection including SVM, tree-based techniques, and artificial neural networks for learning on the datasets. In the illustrated implementation, SVMs are selected for learning on the datasets. Groups of SVMs 510, 512, 514, 516, and 518 are trained based on a family of feature sets within each of datasets from first data 502 and datasets from second data 504, and from subsample data 508A, 508B, and 508C (subsample of datasets) resulting from the need to reduce the size of data used in any single computation. A family of feature sets can be chosen within each dataset that provide predictive power for the final modeler. Sets of information-containing features can be chosen using iterative feature addition or another method, with elimination of features from the set under consideration and retraining used to make a more diverse set of models for the ensemble.

Each of SVMs 510, 512, 514, 516, and 518 are tested for accuracy. Accuracy can be determined by identifying models that predict correct outcomes. A test set of data can be omitted or held out from each sub-dataset of each dataset to determine accuracy. Low marginal predictive power can be judged based on a model's inability to produce the correct classification more often than, for example, twice the rate produced expected from random chance. The testing can also identify overfitting by determining whether models are less accurate on the test dataset than the training dataset. Models with insufficient predictive power or that show overfitting can be discarded.

Overall weighting of each model within each dataset can be determined. Each model set (SVMs with predictive power 520, 522, 524, 526, and 528) is transmitted to a prediction server/engine along with the weights of each model within each dataset and the number of examples in each feature set to form overall ensemble 540. Voting weights 530, 532, 534, 536, and 538 can be assigned to SVMs with predictive power 520, 522, 524, 526, and 528, respectively. The voting weights can be scaled to the amount of data input into the model building (the number of examples used in a model). Relative weights of each of the sets of models can be determined based on the number of examples provided from the training data for each of the datasets. In one example, according to a power law, each ensemble is assigned a number of votes proportional to the amount of data used, raised to a constant determined based on the performance of the models on training and test data. Alternatively, a separate dataset or sub-dataset can be utilized to assign the relative weights of models from different datasets. In another implementation, sets of SVMs that show more accurate predictions are given greater weight over other sets of SVMs.

Prediction server/engine comprises an end classifier that summarizes and combines overall ensemble 540. Input data (e.g., operational data, such as system operating parameters, application queries, such as for insurance or financial product applications, etc.) can be submitted to the prediction engine for classification and analysis of the input data. In the underwriting example, an application query can include information associated with an insurance or financial product application and underwriting results. The prediction engine is then operable to extract features from the application information and run the overall ensemble 540 with the features to produce outcome variables and an uncertainty factor for the outcome variables. Scores can be assigned to various outcome variables produced from overall ensemble 540 such as a life score that predicts a year range of life expectancy. An uncertainty range is produced to indicate the quality of classification of the outcome variable. Drivers of a predicted outcome can also be determined by performing a sensitivity analysis of the combined models to determine which values of which features are the largest drivers of a given outcome. Similar operations can be performed in classifying input operational data to produce outcome variables relating to equipment failures, maintenance needs, etc., and an uncertainty factor for the outcome variables.

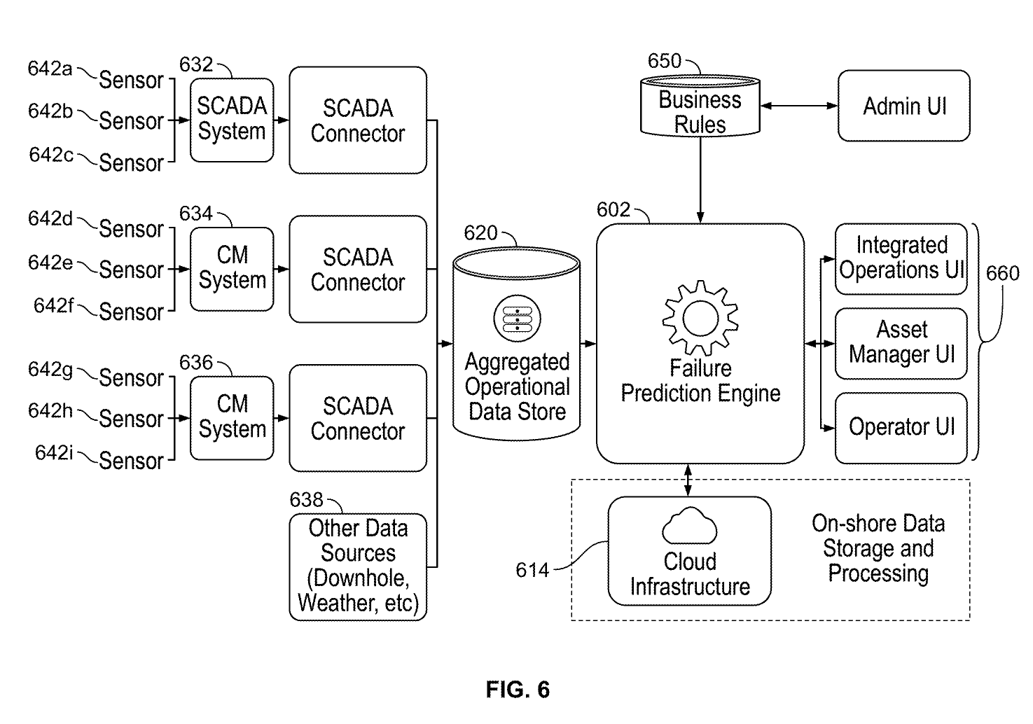

FIG. 6 depicts a computing system according to one implementation. Example applications of the computing system according to this implementation include, but are not limited to, predicting industrial asset and equipment failures and maintenance needs. The computing system includes failure prediction engine 602 in communication with cloud infrastructure 614 via, for example, a wired or wireless network. In one implementation, cloud infrastructure 614 includes historical data subsystem 230. The failure prediction engine 602 has access to aggregated operation data store 620, which stores on a suitable computer-readable medium data received from various data source, such as SCADA system 632, continuous monitoring (CM) systems 634 and 636, and other data sources 638 (e.g., weather monitoring systems, downhole sensory systems, and the like). SCADA system 632 and CM systems 634 and 636 are operationally coupled to various sensors 642a-642i to receive and monitor sensor signals and system operational parameters (e.g., force, flow rate, vibration, temperature, fluid level, pressure, etc.).

Based on real-time and historical sensor data, maintenance logs, historical failure data, and other information, failure prediction engine 602 can generate, in a manner such as that described herein, a customized model configured to predict asset breakdowns, failures, and other maintenance needs for a particular industrial or other system (e.g., an oil rig). Failure prediction engine 602 can also utilize business rules 650 to determine the sensitivity of models (e.g., tradeoffs between precision and recall). The allows system end users to tune outcomes so that, for example, more alerts are generated for systems where unplanned failures are more costly than preventative maintenance, and alerts not generated or less frequently generated on systems permitting more failures. Further, user interface (UI) components 660 enable the end user(s) to configure business rules 650 and provide feedback to failure prediction engine 602 on whether models have or have not been successful in predicting failures or other outcomes. The feedback can be communicated to failure prediction engine 602 to improve the models.

The generated model and/or data associated with use of the model can be transmitted to cloud infrastructure 614, which can combine it with models generated by and received from other systems in order to form an ensemble model. The ensemble model can then be transmitted from cloud infrastructure 614 to failure prediction engine 602 (as well as to failure prediction systems hosted elsewhere) to improve its predictive abilities. Sharing the ensemble model, rather than sharing the data that the model is trained on, can be advantageous in that parties, unrelated or otherwise, are able to benefit from the experiences of others with similar operations or equipment without having to distribute confidential or otherwise sensitive data. For example, two equipment operators can enter into a joint venture oil drilling that restricts the sharing of operational data between the two operators, but allows each to utilize a model that has been trained using all of the available data. Specific models (or model components) can be designated as anonymous/non-anonymous (i.e., whether the source of the model or model component is identifiable) and/or shareable/non-shareable (i.e., whether the model is permitted to be shared with others). In some implementations, fees associated with shared or other models can be adjusted based on usage of the models as well as based on data contributed to a model. For example, if a particular operator contributes significant amounts of training data for a combined model that is shared with other operators, the first operator can be charged comparatively less for their usage of the shared model, potentially through a rebate model. In some instances, the fees can be zero or negative amounts (e.g., the first operator's cost for using the models does not exceed the benefit received for providing training data, etc.).

In some instances, where network bandwidth or connectivity between failure prediction engine 602 and cloud infrastructure 614 is intermittent, limited, slow, or infrequent (e.g., failure prediction engine 602 is hosted on a server on an oil rig in the Pacific ocean, and cloud infrastructure 614 is situated on shore), data transmissions between the two can be refined and limited accordingly. For example, rather than failure prediction engine 602 continuously sending and receiving model updates to and from cloud infrastructure 614, transmissions can occur asynchronously, when connectivity and appropriate bandwidth are available. Further, the transmitted data can be compressed or otherwise condensed, which can include encrypting and anonymizing the data (rather than sending raw data).

Real-time sensor data and other input information from SCADA system 632, CM systems 634 and 636, and/or other data sources 638 can be input into the customized generated model and/or the ensemble model to provide an outcome prediction. The outcome prediction can include outcome variables associated with equipment, component, vehicle, machine, system, or other asset maintenance, failure data, uptime, and/or productivity.

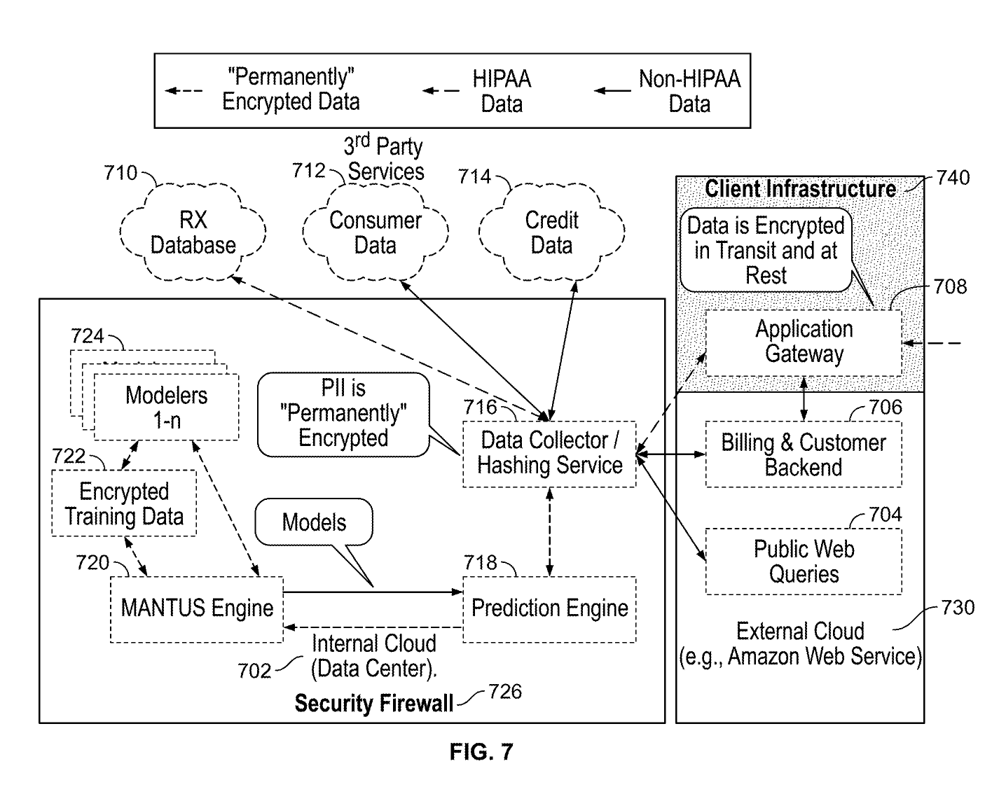

FIG. 7 presents a computing system according to another implementation. Example applications of the computing system according to this implementation include, but are not limited to, financial and insurance underwriting, and risk management. The computing system comprises an internal cloud 702, external cloud 730, and client infrastructure 740. Internal cloud 702 can be hosted on one or more servers that are protected behind a security firewall 726. In the illustrated implementation, internal cloud 702 is configured as a data center and includes MANTUS (mutually anonymous neutral transmission of underwriting signals) engine 720. MANTUS engine 720 is configured to receive encrypted training data 722.

Encrypted training data 722 includes features extracted from policies provided by a plurality of underwriting parties. The policies comprising personal identifying information, date or birth, original underwriting information, publicly purchasable consumer data, and death or survival outcomes. Modelers 724 are capable of learning from the encrypted training data 722 to train models. Trained models can be transmitted to prediction engine 718 to form an end ensemble classifier for analyzing new applications and predicting outcomes. The outcomes can include variables, uncertainty ranges, and drivers of the outcome variables. Internal cloud 702 further includes data collector/hashing service 716. Data collector/hashing service 716 is operable to receive queries for new or existing applications via application gateway 708 and encrypt the personally identifiable information via asymmetric encryption.

Client infrastructure 740 includes application gateway 708 where an underwriting party can submit queries for insurance or financial product applications from remote client devices. The queries can comprise applicant data including personal identifying information (such as name, age, and date of birth), policy information, underwriting information, an outcome variable for life expectancy as calculated from the underwriters' decision, and actuarial assumptions for a person in an underwriting class and of that age. Client devices can comprise general purpose computing devices (e.g., personal computers, mobile devices, terminals, laptops, personal digital assistants (PDA), cell phones, tablet computers, or any computing device having a central processing unit and memory unit capable of connecting to a network). Client devices can also comprise a graphical user interface (GUI) or a browser application provided on a display (e.g., monitor screen, LCD or LED display, projector, etc.).

A client device can also include or execute an application to communicate content, such as, for example, textual content, multimedia content, or the like. A client device can also include or execute an application to perform a variety of possible tasks. A client device can include or execute a variety of operating systems, including a personal computer operating system, such as a Windows, Mac OS or Linux, or a mobile operating system, such as iOS, Android, or Windows Mobile, or the like. A client device can include or can execute a variety of possible applications, such as a client software application enabling communication with other devices, such as communicating one or more messages, such as via email, short message service (SMS), or multimedia message service (MMS), including via a network, such as a social network, including, for example, Facebook, LinkedIn, Twitter, Flickr, or Google+, to provide only a few possible examples. The term “social network” refers generally to a network of individuals, such as acquaintances, friends, family, colleagues, or co-workers, coupled via a communications network or via a variety of sub-networks. A social network can be employed, for example, to identify additional connections for a variety of activities, including, but not limited to, dating, job networking, receiving or providing service referrals, content sharing, creating new associations, maintaining existing associations, identifying potential activity partners, performing or supporting commercial transactions, or the like.

Data collector/hashing service 716 is further operable to retrieve data from various sources of data such as third party services including RX database 710, consumer data 712, and credit data 714, and from public web queries 704 on external cloud 730. RX database 710 includes medical prescription records and health histories. Consumer data 712 includes retail purchasing information (e.g., from Ebay, Amazon, Starbucks, Seamless, Groupon, OpenTable, etc.), services (e.g., Netflix, Nexus Lexis), memberships (e.g., gym, automobile, and professional associations such as IEEE). Public web queries 704 can include searches for “hits” associated with applicants' names on the Internet, driving records, criminal records, and applicants' social network profiles (e.g., LinkedIn, Facebook, Twitter, etc.). Several features of applicants can be extracted from the RX database 710, consumer data 712, credit data 714, and from public web queries 704.

The information provided in the application queries and the retrieved data can be transmitted to prediction engine 718 for analysis and prediction. Prediction engine 718 includes a plurality of models and is operable to input the application data and the retrieved data into the models. The prediction engine 718 summarizes and combines results from the ensemble of models to generate one or more outcome variables and provide an uncertainty range. The prediction engine 718 further operable to determine drivers of the outcome variables by varying certain features and determining which of the varied features are major contributors to the outcome variables. After completion of analysis and prediction by prediction engine 718, results (outcome variables, uncertainty ranges, and drivers) can be uploaded to collector/hashing service 716 to return the result to application gateway 708. The external cloud 730 further includes billing and customer backend 706. Billing and customer backend 706 is operable to track the progress of application queries and notify application gateway 708 when outcome data is ready.

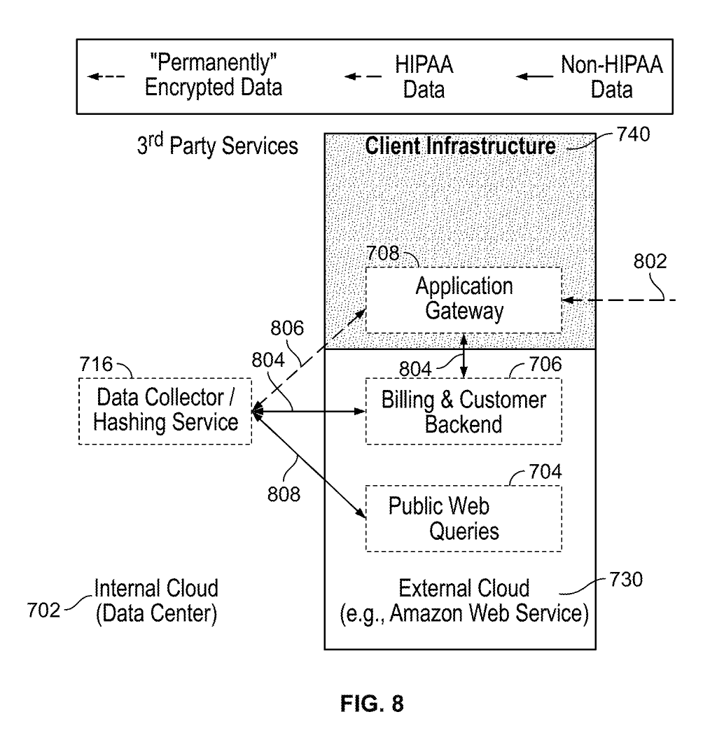

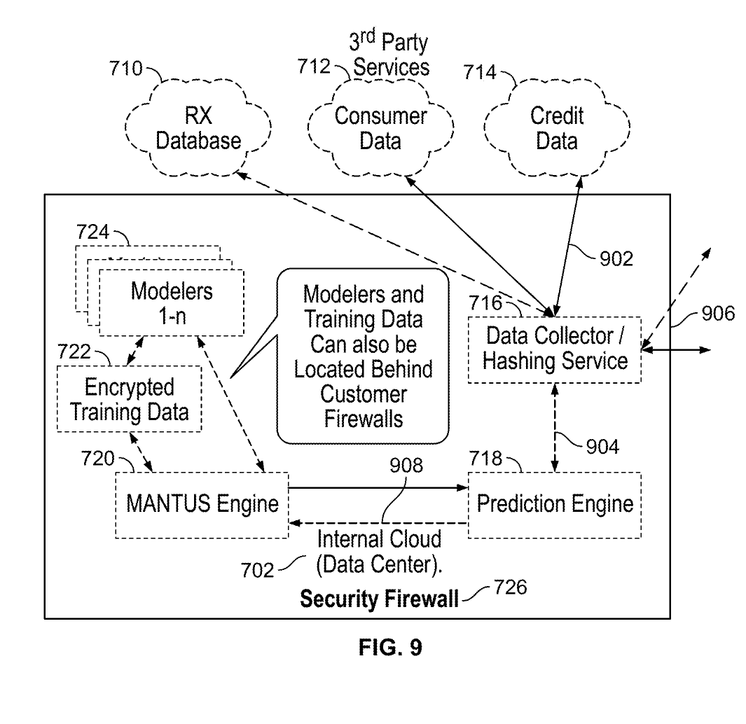

FIG. 8 and FIG. 9 present data flow diagrams of a system for predicting outcomes for insurance and financial product applications according to an implementation. Referring to FIG. 8, application data is sent from a client device of an underwriter to application gateway server 708 on client infrastructure 740, step 802. Application data includes personal identifying information (such as name, age, and date of birth), policy information, underwriting information, an outcome variable for life expectancy as calculated from the underwriters' decision, and actuarial assumptions for a person in an underwriting class and of that age. A job for the application data is created and progress is tracked throughout the cycle by billing and customer backend 706, step 804. Tracking the progress of the job further includes notifying application gateway 708 when the job is complete and ready for transmission to the underwriter. The application data is uploaded from the application gateway server 708 to data collector/hashing service 716, step 806. Application data uploaded to the data collector/hashing service 716 can be uploaded via secured transfer. In a next step 808, data collector launches web queries for additional data lookup. The web queries can include searching public data (e.g., available on the Internet) associated with applicants in connection with the application data.

Referring to FIG. 9, data collector/hashing service 716 is configured to query third party services (RX database 710, consumer data 712, and credit data 714) to acquire additional data, step 902. Personal identification information contained in the additional data can be hashed or encrypted by data collector/hashing service 716. Prediction engine runs the ensemble of models and returns the result(s) to data collector/hashing service 716, step 904. Billing and customer backend 706 receives status reports on the job, while the application gateway 708 receives the result(s) from data collector/hashing service 716, step 906. Encrypted data (application data and additional data) is sent to MANTUS engine 720 for model re-building, step 908.

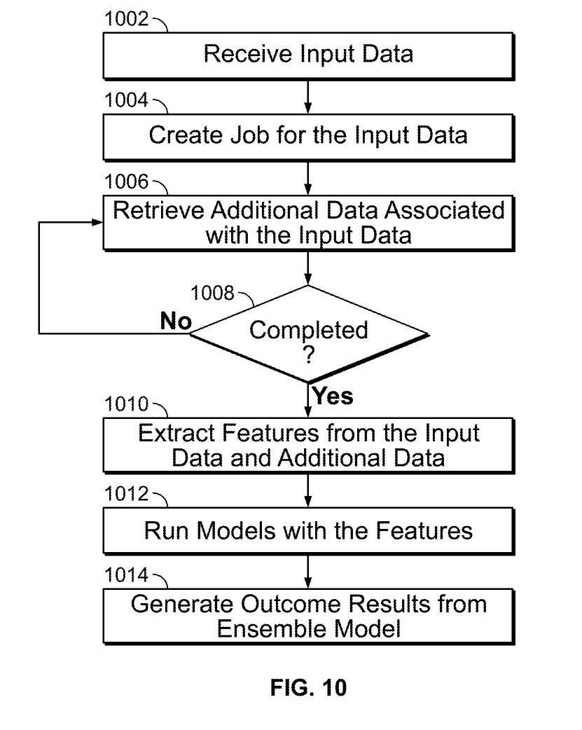

FIG. 10 illustrates a flowchart of a method for predicting an outcome based on an ensemble model according to an implementation. A prediction server receives input data, step 1002. Depending on the use case, input data can include, for example, real-time equipment operational data (e.g., sensor readings, environmental information, etc.), financial or insurance application data (e.g., personal identifying information (such as name, age, and date of birth), policy information, underwriting information, an outcome variable for life expectancy as calculated from the underwriters' decision, and actuarial assumptions for a person in an underwriting class and of that age), and so on. A job is created for the input data, step 1004. The job comprises processing of the input data to produce an outcome prediction by the prediction server.

Additional data associated with the input data can also be retrieved, step 1006. The additional data can include, for example, historical equipment maintenance and operational data, manufacturer specifications, information associated with an applicant (e.g., prescription records, consumer data, credit data, driving records, medical records, social networking/media profiles, and any other information useful in characterizing an individual for an insurance or credit (as well as other financial products) applications), and so on. Progress of the retrieval of additional data is monitored, step 1008. Upon completion of the additional data retrieval, features from the input data and the additional data are extracted, step 1010. The features are provided as inputs to the ensemble model stored on the prediction server. Each of the sub-models in the ensemble model are run with the extracted features 1012. Outcome results are generated from the ensemble model, step 1014. The results include outcome variables, uncertainty ranges, and drivers. According to one implementation, a combination of at least one of an outcome variable or score, certainty/uncertainty ranges, drivers, and lack of data can be translated to, for example, an asset failure prediction; maintenance need prediction; shutdown requirement; underwriting, credit, or risk prediction, etc., by using a translation table or other rules based engine.

The figures are conceptual illustrations allowing for an explanation of the present techniques. It should be understood that various aspects of the implementations in the present disclosure can be implemented in hardware, firmware, software, or combinations thereof. In such implementations, the various components and/or steps would be implemented in hardware, firmware, and/or software to perform the functions in the present disclosure. That is, the same piece of hardware, firmware, or module of software could perform one or more of the illustrated blocks (e.g., components or steps).

In software implementations, computer software (e.g., programs or other instructions) and/or data is stored on a machine readable medium as part of a computer program product, and is loaded into a computer system or other device or machine via a removable storage drive, hard drive, or communications interface. Computer programs (also called computer control logic or computer readable program code) are stored in a main and/or secondary memory, and executed by one or more processors (controllers, or the like) to cause the one or more processors to perform the functions of the invention as described herein. In this document, the terms “machine readable medium,” “computer readable medium,” “computer program medium,” and “computer usable medium” are used to generally refer to media such as a random access memory (RAM); a read only memory (ROM); a removable storage unit (e.g., a magnetic or optical disc, flash memory device, or the like); a hard disk; or the like.

Processors suitable for the execution of a computer program include, by way of example, both general and special purpose microprocessors, and any one or more processors of any kind of digital computer. Generally, a processor will receive instructions and data from a read-only memory or a random access memory or both. The essential elements of a computer are a processor for executing instructions and one or more memory devices for storing instructions and data. Information carriers suitable for embodying computer program instructions and data include all forms of non-volatile memory, including by way of example semiconductor memory devices, e.g., EPROM, EEPROM, and flash memory devices; magnetic disks, e.g., internal hard disks or removable disks; magneto-optical disks; and CD-ROM and DVD-ROM disks. One or more memories can store media assets (e.g., audio, video, graphics, interface elements, and/or other media files), configuration files, and/or instructions that, when executed by a processor, form the modules, engines, and other components described herein and perform the functionality associated with the components. The processor and the memory can be supplemented by, or incorporated in special purpose logic circuitry.

Networks and communication links described herein can include any media such as standard telephone lines, LAN or WAN links (e.g., T1, T3, 56 kb, X.25), broadband connections (ISDN, Frame Relay, ATM), wireless links (802.11, Bluetooth, GSM, CDMA, etc.), and so on. The network can carry TCP/IP protocol communications and HTTP/HTTPS requests made by a web browser, and the connection between clients and servers can be communicated over such TCP/IP networks. The type of network is not a limitation, however, and any suitable network can be used.

The terms and expressions employed herein are used as terms and expressions of description and not of limitation, and there is no intention, in the use of such terms and expressions, of excluding any equivalents of the features shown and described or portions thereof. In addition, having described certain implementations in the present disclosure, it will be apparent to those of ordinary skill in the art that other implementations incorporating the concepts disclosed herein can be used without departing from the spirit and scope of the invention. The features and functions of the various implementations can be arranged in various combinations and permutations, and all are considered to be within the scope of the disclosed invention. Accordingly, the described implementations are to be considered in all respects as illustrative and not restrictive. The configurations, materials, and dimensions described herein are also intended as illustrative and in no way limiting. Similarly, although physical explanations have been provided for explanatory purposes, there is no intent to be bound by any particular theory or mechanism, or to limit the claims in accordance therewith.

1. A computer-implemented method comprising:
receiving, at one or more central site servers from one or more data sources, historical data associated with a plurality of outcomes;
generating, by the central site servers, a plurality of datasets from the historical data;
training, by the central site servers and using the datasets, a set of models to predict an outcome, wherein a particular model in the set of models comprises a plurality of sub-models corresponding to a hierarchy of components of an industrial asset;
combining, by the central site servers, the set of models into an ensemble model; and
transmitting, from the central site servers, the ensemble model to one or more remote sites.

2. The method of claim 1, wherein the historical data associated with the plurality of outcomes comprises at least one of historical asset failure data, maintenance log data, and environmental data.

3. The method of claim 1, wherein each of the remote sites is configured to:
receive at least one of real-time data and historical data associated with operation of the remote site; and
predict, using at least one of a customized model and the ensemble model, an outcome based on the at least one of real-time data and historical data.

4. The method of claim 3, wherein a particular predicted outcome comprises at least one of a prediction that an asset or a component of an asset is likely to fail, a prediction that an asset or a component of an asset is likely to require maintenance, a prediction of uptime of an asset or a component of an asset, and a prediction of productivity of an asset or a component of an asset.

5. The method of claim 3, wherein a particular predicted outcome comprises a decision relating to underwriting, pricing, or feature activation of an insurance or financial product associated with an industrial activity or installation.

6. The method of claim 3, wherein each of the remote sites is further configured to:
generate an uncertainty factor based on a lack of information about the predicted outcome; and
determine whether a shutdown of an asset is warranted based at least in part on the uncertainty factor.

7. The method of claim 3, wherein the real-time data and historical data associated with the operation of the remote site comprise one or more of sensor data associated with operation of equipment at the remote site, and environmental data.

8. The method of claim 1, wherein the remote sites comprise industrial sites associated with at least one of oil exploration, gas exploration, energy production, mining, chemical production, drilling, refining, piping, automobile production, aircraft production, supply chains, and general manufacturing.

9. The method of claim 1, wherein each of the remote sites is configured to transmit to one or more of the central site servers feedback data associated with a model used by the remote site.

10. The method of claim 9, further comprising:
receiving, at the central site servers from one or more of the remote sites, the feedback data associated with a model used by the remote site; and
updating, by the central site servers, the ensemble model based on the feedback data.

11. The method of claim 10, wherein the receiving of the feedback data from each of the remote sites occurs asynchronously based on network connectivity of the remote site.

12. The method of claim 10, further comprising transmitting, from the central site servers, the updated ensemble model to one or more of the remote sites.

13. The method of claim 1, wherein data transmitted between the central site servers and the remote sites is compressed prior to transmission.

14. The method of claim 1, wherein a particular remote site is configured to train a customized model used by the remote site to predict an outcome using at least one of real-time data and historical data associated with one or more assets at the particular remote site.

15. The method of claim 1, wherein a particular remote site is configured to transmit to one or more of the central site servers a particular model used by the remote site, wherein the particular model is designated as shareable or not shareable with other remote sites.

16. The method of claim 1, wherein fees paid by a particular remote site for use of the ensemble model are based on at least one of the particular remote site providing a model to the central site servers, the particular remote site providing data associated with usage of a model to the central site servers, and an amount of usage of the ensemble model by the particular remote site.

17. The method of claim 1, wherein combining the set of models into the ensemble model comprises:
determining a weighting of each model in the set of models based on a predictive power of the model; and
combining the set of models into the ensemble model based at least in part on the weighting of the models.

18. The method of claim 1, further comprising pre-processing, by the central site servers, historical data to anonymize information that could identify a person or entity.

19. A system comprising:
at least one memory for storing computer-executable instructions; and
at least one processor for executing the instructions stored on the at least one memory, wherein execution of the instructions programs the at least one processor to perform operations comprising:
receiving, at one or more central site servers from one or more data sources, historical data associated with a plurality of outcomes;
generating, by the central site servers, a plurality of datasets from the historical data;
training, by the central site servers and using the datasets, a set of models to predict an outcome, wherein a particular model in the set of models comprises a plurality of sub-models corresponding to a hierarchy of components of an industrial asset;
combining, by the central site servers, the set of models into an ensemble model; and
transmitting, from the central site servers, the ensemble model to one or more remote sites.

20. The system of claim 19, wherein the historical data associated with the plurality of outcomes comprises at least one of historical asset failure data, maintenance log data, and environmental data.

21. The system of claim 19, wherein each of the remote sites is configured to:
receive at least one of real-time data and historical data associated with operation of the remote site; and
predict, using at least one of a customized model and the ensemble model, an outcome based on the at least one of real-time data and historical data.

22. The system of claim 21, wherein a particular predicted outcome comprises at least one of a prediction that an asset or a component of an asset is likely to fail, a prediction that an asset or a component of an asset is likely to require maintenance, a prediction of uptime of an asset or a component of an asset, and a prediction of productivity of an asset or a component of an asset.

23. The system of claim 21, wherein a particular predicted outcome comprises a decision relating to underwriting, pricing, or feature activation of an insurance or financial product associated with an industrial activity or installation.

24. The system of claim 21, wherein each of the remote sites is further configured to:
generate an uncertainty factor based on a lack of information about the predicted outcome; and
determine whether a shutdown of an asset is warranted based at least in part on the uncertainty factor.

25. The system of claim 21, wherein the real-time data and historical data associated with the operation of the remote site comprise one or more of sensor data associated with operation of equipment at the remote site, and environmental data.

26. The system of claim 18, wherein the remote sites comprise industrial sites associated with at least one of oil exploration, gas exploration, energy production, mining, chemical production, drilling, refining, piping, automobile production, aircraft production, supply chains, and general manufacturing.

27. The system of claim 18, wherein each of the remote sites is configured to transmit to one or more of the central site servers feedback data associated with a model used by the remote site.

28. The system of claim 27, wherein the operations further comprise:
receiving, at the central site servers from one or more of the remote sites, the feedback data associated with a model used by the remote site; and
updating, by the central site servers, the ensemble model based on the feedback data.

29. The system of claim 28, wherein the receiving of the feedback data from each of the remote sites occurs asynchronously based on network connectivity of the remote site.

30. The system of claim 28, wherein the operations further comprise transmitting, from the central site servers, the updated ensemble model to one or more of the remote sites.

31. The system of claim 18, wherein data transmitted between the central site servers and the remote sites is compressed prior to transmission.

32. The system of claim 18, wherein a particular remote site is configured to train a customized model used by the remote site to predict an outcome using at least one of real-time data and historical data associated with one or more assets at the particular remote site.

33. The system of claim 18, wherein a particular remote site is configured to transmit to one or more of the central site servers a particular model used by the remote site, wherein the particular model is designated as shareable or not shareable with other remote sites.

34. The system of claim 18, wherein fees paid by a particular remote site for use of the ensemble model are based on at least one of the particular remote site providing a model to the central site servers, the particular remote site providing data associated with usage of a model to the central site servers, and an amount of usage of the ensemble model by the particular remote site.

35. The system of claim 18, wherein combining the set of models into the ensemble model comprises:
determining a weighting of each model in the set of models based on a predictive power of the model; and
combining the set of models into the ensemble model based at least in part on the weighting of the models.

36. The system of claim 18, wherein the operations further comprise pre-processing, by the central site servers, historical data to anonymize information that could identify a person or entity.

37. A non-transitory computer-readable medium storing instructions that, when executed, program at least one processor to perform operations comprising:
receiving, at one or more central site servers from one or more data sources, historical data associated with a plurality of outcomes;
generating, by the central site servers, a plurality of datasets from the historical data;
training, by the central site servers and using the datasets, a set of models to predict an outcome, wherein a particular model in the set of models comprises a plurality of sub-models corresponding to a hierarchy of components of an industrial asset;
combining, by the central site servers, the set of models into an ensemble model; and
transmitting, from the central site servers, the ensemble model to one or more remote sites.
